(19) United States
(12) Patent Application Publication
(10) Pub. No.: US 2013/0181514 A1
(43) Pub. Date: Jul. 18, 2013

(54) POWER SOURCE APPARATUS

(71) Applicants: Seiji Ikeda, Ota-shi (JP); Junya Yano, Kasai-shi (JP)

(72) Inventors: Seiji Ikeda, Ota-shi (JP); Junya Yano, Kasai-shi (JP)

(21) Appl. No.: 13/823,465

(22) PCT Filed: Sep. 27, 2011
(86) PCT No.: PCT/JP2011/072124

§ 371 Date: Apr. 3, 2013

(30) Foreign Application Priority Data
Sep. 30, 2010 (JP) 2010-223160
Jun. 15, 2011 (JP) 2011-133633

(51) Int. Cl. B60R 16/03; H02J 1/00

(52) U.S. Cl. CPC B60R 16/03; H02J 1/00
USPC 307/10.1; 307/77

(57) ABSTRACT

A power source apparatus is provided with a plurality of battery modules connected in series, and a voltage detection circuit to detect the voltage of each battery module. Bypass-capacitors are connected at both ends of each voltage detection line to connect all adjacent voltage detection lines in series and form a series-connected line. A resistive element is connected between the bypass-capacitor at the battery module end of each voltage detection line and the battery module electrode terminal to connect one end of each voltage detection line to a battery module. A signal generator that outputs AC or pulse detection signals is connected to one end of the series-connected line while a signal detection circuit is provided at the other end of the series-connected line. Detection signals output from the signal generator are detected by the signal detection circuit to detect failure in the series-connected voltage detection lines.

### BACKGROUND OF THE INVENTION

1. Field of the Invention

The present invention relates to a power source apparatus that powers a motor to drive an electric-powered vehicle such as a hybrid vehicle (hybrid car, hybrid electric vehicle, HEV) or electric vehicle (EV, electric automobile), and in particular, to a power source apparatus equipped with voltage detection circuitry to detect the voltages of battery modules connected in series.

2. Description of the Related Art

A power source apparatus, such as one that supplies power to a motor to drive an electric-powered vehicle, has many battery modules connected in series to increase the output voltage and power. A power source apparatus that powers a hybrid vehicle or electric vehicle has an output voltage of 200V or more to increase the power that can be delivered to the motor.

In a battery made up of many series-connected battery modules, it is important to conduct charging and discharging while preventing each battery module from over-charging or over-discharging. This is because over-charging and over-discharging degrade battery performance and degradation reduces battery lifetime. A power source apparatus is provided with voltage detection circuitry that detects battery module voltages to control charging and discharging currents according to the detected voltages and prevent battery module over-charging and over-discharging.

The voltage detection circuit 93 in FIG. 1 detects the voltage at each battery module 92 connecting node 97 with respect to a reference node 98 near the mid-potential of all the battery modules 92 to compute the voltage of each battery module 92. This voltage detection circuit 93 determines battery module 92 voltage from the difference between the voltages at the connecting nodes of each battery module 92. Since this voltage detection circuit 92 detects battery module 92 connecting node 97 voltages with respect to the reference node 98, all the detected voltages are voltages with respect to the reference node 98. Accordingly as shown in the figure, connecting node 97 voltages can be detected by switching the selected battery module 92 connecting node 97 via a multiplexer 94. Although the voltage detection circuit 93 shown in FIG. 1 detects voltages with respect to a reference node 98 to determine the voltage of each battery module 92, a voltage detection circuit could also directly detect the voltage of each battery module with a difference amplifier.

The voltage detection circuit is connected to the positive and negative electrode terminals of each battery module via voltage detection lines. The voltage detection lines are made up of lead-wires and connectors with one end connected to a battery module positive or negative electrode terminal and the other end connected to the input-side of the voltage detection circuit. A voltage detection line can fail to input correct battery module voltage to the voltage detection circuit due to voltage detection line malfunctions such as lead-wire open-circuit or connector contact resistance. If a voltage detection line malfunction occurs and the voltage detection circuit cannot detect correct voltages for all the battery modules, battery module charging and discharging cannot be properly controlled. This is because over-charging or over-discharging cannot be detected in a battery module with undetected voltage.

To avoid this detrimental situation, power source apparatus have been developed that detect lead-wire open-circuit and connector contact resistance in the voltage detection lines that connect the positive and negative electrode terminals of the battery modules with the voltage detection circuit.

The open-circuit detection circuit cited in Japanese Patent Publication 2009-95222 is shown in FIG. 2. This open-circuit detection circuit 80 has diodes 84 connected in parallel with the batteries 82. The diodes 84 are connected with a polarity that does not discharge the batteries 82. Accordingly, the voltage across each battery 82 and the voltage across each forward-biased diode 84 are of opposite polarity. More specifically, the positive-side of each battery 82 is the negative-side of each forward-biased diode 84. During open-circuit detection, current is forced to flow through each parallel-connected battery 82 and diode 84 in the forward-bias direction of the diode 84. Under these conditions, the voltage across the diode 84 becomes the voltage across the battery 82. This is because the battery 82 is connected in parallel with the diode 84. However, if a voltage detection line 88 between the diode 84 and battery 82 is open-circuited, the battery 82 becomes disconnected from the diode 84 and a voltage opposite the polarity of the battery voltage is detected across the diode 84. This open-circuit detection circuit 80 can detect voltage detection line 88 open-circuits by detecting the voltage across the diodes. This is because battery 82 voltage is detected when there is no voltage detection line 88 open-circuit. However, when a voltage detection line 88 is open-circuited, forward-biased diode 84 voltage is detected instead of the battery 82 voltage. This open-circuit detection circuit 80 has the drawback that circuit structure becomes extremely complex. In addition, it has the drawback that operations to detect an open-circuit are intricate.

The open-circuit detection circuit cited in Japanese Patent Publication 2009-257923 is shown in FIG. 3. This open-circuit detection circuit 70 has a Zener diode 74, which has a Zener breakdown higher than the battery 72 voltage, connected in parallel with each battery 72. This circuit also has a series-connected resistor 76 and switch 77 to pass current through each Zener diode 74. With the switch 77 in the ON state, this open-circuit detection circuit 70 detects the voltage across the Zener diode 74 to determine voltage detection line 78 open-circuit. This is possible because the voltage across the Zener diode 74 changes when a voltage detection line 78 is open-circuited. This open-circuit detection circuit 70 also has the drawback of circuit complexity. Further, since voltage detection line 78 open-circuit is determined by detecting the voltage across each Zener diode 74, it also has the drawback that detection operations are complex.

Further, the open-circuit detection circuit cited in Japanese Patent Publication 2009-288034 is shown in FIG. 4. Since many switches 67 are switched to detect voltage detection line 68 open-circuit, this open-circuit detection circuit 60 also has the drawbacks of complex circuit structure and intricate operation.

The present invention was developed to resolve drawbacks in the open-circuit detection circuits described above. Thus, it is an object of the present invention to provide a power source apparatus, which can perform open-circuit detection in all the voltage detection lines simultaneously with a simple circuit structure and operating scheme, to determine whether or not battery module voltage can be accurately detected and allow charging and discharging while protecting the battery modules from over-charging and over-discharging.

### SUMMARY OF THE INVENTION

The power source apparatus of the present invention is provided with a plurality of battery modules connected in series, and a voltage detection circuit connected to the positive and negative electrode terminals of each battery module via voltage detection lines to detect the voltage of each battery module. The power source apparatus has bypass-capacitors connected at both ends of each voltage detection line that connect all adjacent voltage detection lines in series and form a series-connected line. Further, a resistive element is connected between the bypass-capacitor at the battery module end of each voltage detection line and each battery module electrode terminal. This connects one end of each voltage detection line to a battery module electrode terminal through a resistive element. In addition, a signal generator that outputs alternating current (AC) or pulse detection signals is connected to one end of the series-connected line, which is connected in series via the bypass-capacitors. The other end of the series-connected line is provided with a signal detection circuit to detect the detection signals output from the signal generator. The power source apparatus detects the detection signals output from the signal generator with the signal detection circuit to detect failure in the series-connected voltage detection lines.

The power source apparatus described above has the characteristic that it can perform open-circuit detection in all the voltage detection lines simultaneously with an extremely simple circuit structure and operating scheme. This is because all the voltage detection lines are connected in series via bypass-capacitors to form a series-connected line for AC transmission, AC or pulse detection signals are supplied to one end of the series-connected line, and the detection signals are detected at the other end of the series-connected line to detect malfunctions such as open-circuits or connector contact resistance. When all of the voltage detection lines are in a normal condition that can correctly detect voltage, AC or pulse detection signals are transmitted from one end to the other end of the series-connected line. However, if there is a voltage detection line open-circuit or connector contact resistance, detection signal transmission is interrupted and detection signals are not detected at the receiving-end of the series-connected line. Consequently, by issuing detection signals at one end of the series-connected line and detecting those signals at the other end, malfunctions such as open-circuits and connector contact resistance can be determined.

Each resistive element in the power source apparatus of the present invention can be a resistor or a coil (inductor). A power source apparatus with a resistor used as the resistive element can detect voltage detection line failure while reducing component cost. A power source apparatus with a coil used as the resistive element can detect voltage detection line failure while accurately detecting battery module voltage.

The signal generator in the power source apparatus of the present invention can be an oscillator that outputs AC with a frequency of 100 KHz to 100 MHz. Since this power source apparatus supplies AC signals as the detection signals on the series-connected line, voltage detection line failure can be reliably detected.

In the power source apparatus of the present invention, the signal generator can output detection signals to the series-connected line during periods when the voltage detection circuit is not detecting battery module voltages. This power source apparatus has the characteristic that it can accurately detect battery module voltages while detecting voltage detection line malfunction. This is because detection signals to detect voltage detection line malfunction are not supplied to the series-connected line when battery module voltage is being detected. Consequently, the detection signals do not affect detection of the battery module voltages.

In the power source apparatus of the present invention, bypass-capacitor impedance with respect to detection signals issued by the signal generator can be set lower than the electrical resistance of the resistive element. Since bypass-capacitor impedance is set lower than the resistance of the resistive element, this power source apparatus has the characteristic that it can reliably detect voltage detection line malfunction by transmitting detection signals on the series-connected line while reducing effects on the battery modules connected in parallel with the bypass-capacitors.

The power source apparatus of the present invention can be a power source apparatus that supplies power to a motor that drives a vehicle. This power source apparatus can be used with many battery modules to increase output voltage while reliably detecting over-charging and over-discharging in each battery module.

The power source apparatus of the present invention can be an automotive power source apparatus.

The power source apparatus of the present invention can be a power source apparatus for power storage applications.

### BRIEF DESCRIPTION OF THE DRAWINGS

FIG. 1 is a circuit diagram showing a voltage detection circuit for a prior art power source apparatus;

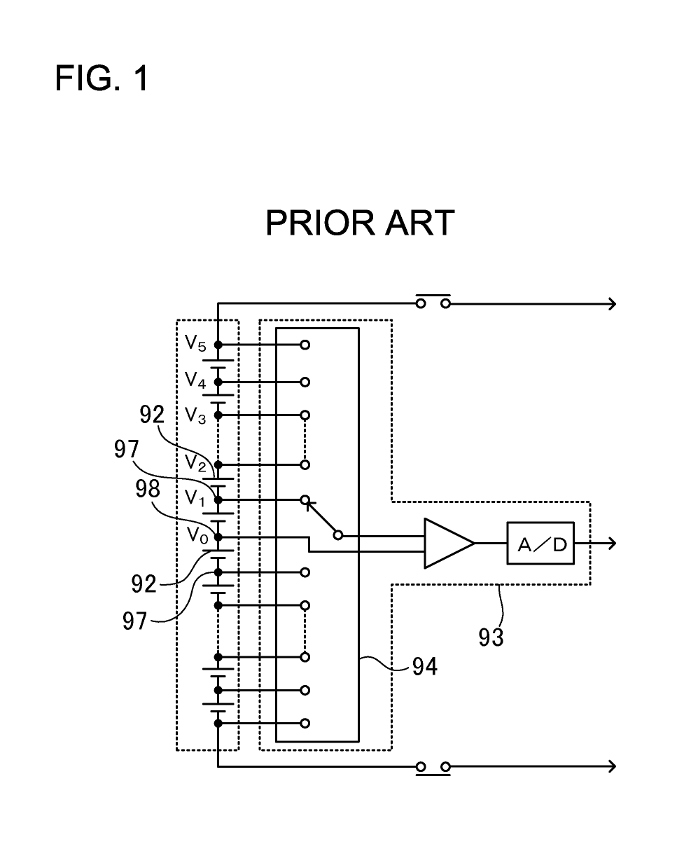

FIG. 2 is a circuit diagram showing an open-circuit detection circuit for a prior art power source apparatus;

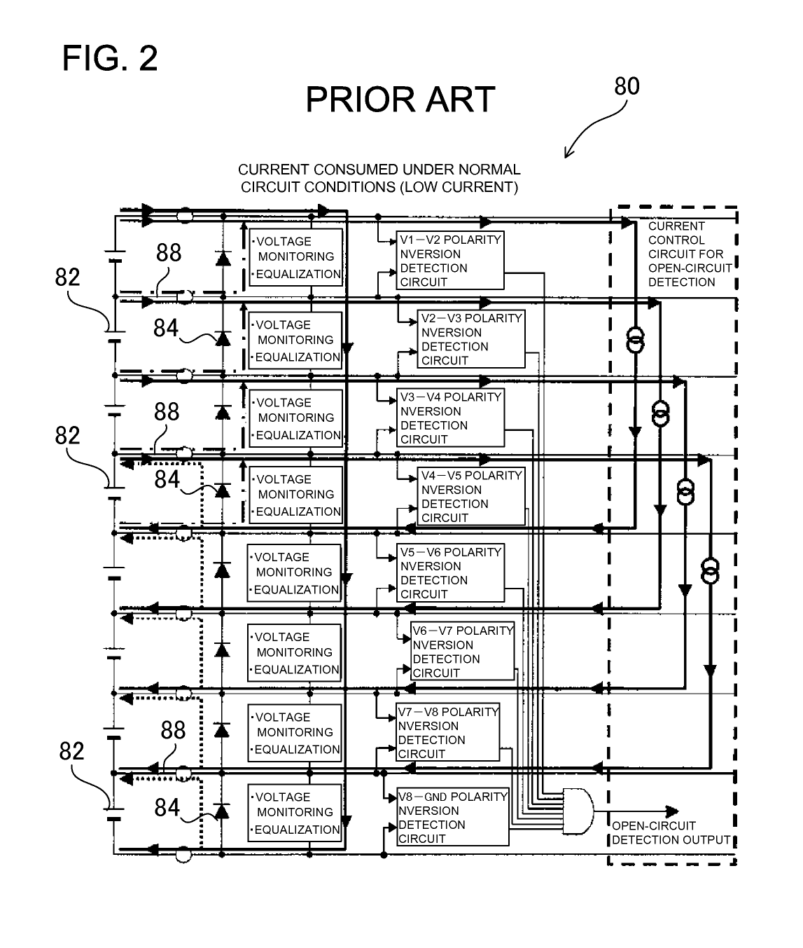

FIG. 3 is a circuit diagram showing an open-circuit detection circuit for another prior art power source apparatus;

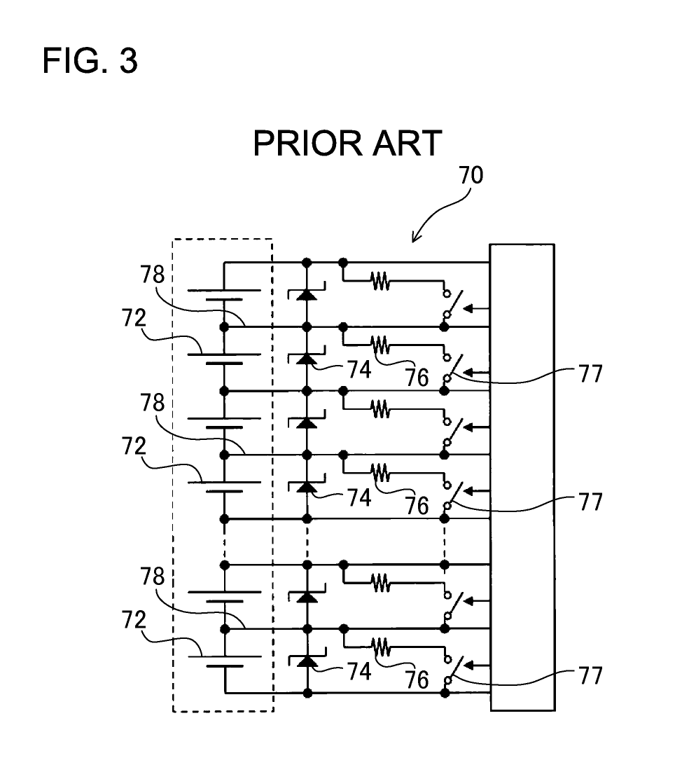

FIG. 4 is a circuit diagram showing an open-circuit detection circuit for another prior art power source apparatus;

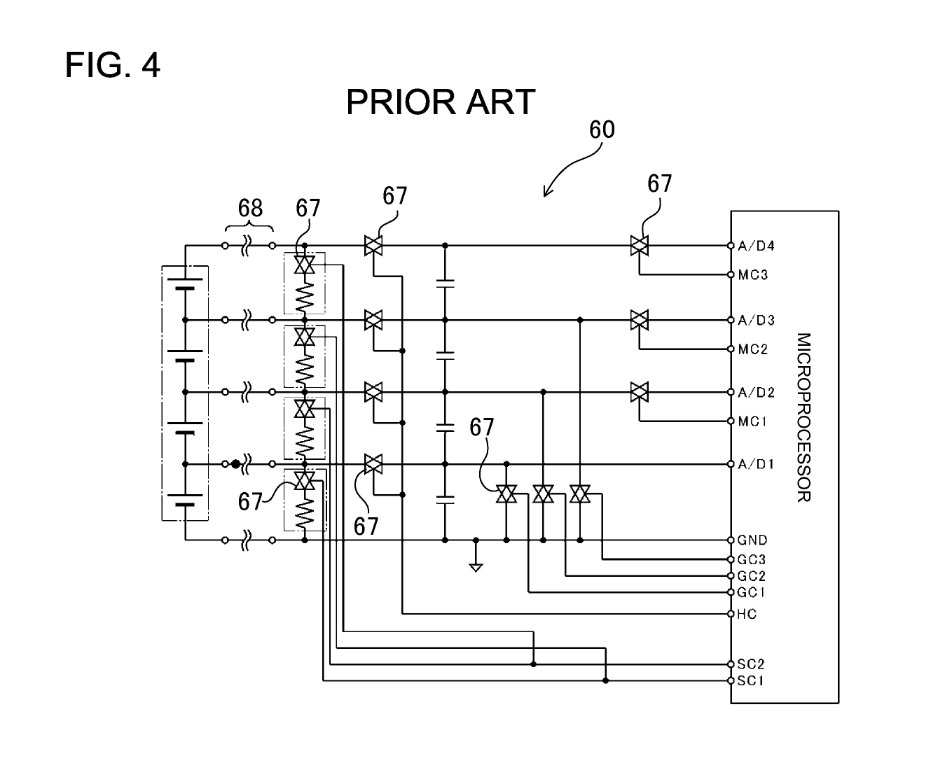

FIG. 5 is an abbreviated schematic of a power source apparatus configuration for an embodiment of the present invention; and

FIG. 6 is a block diagram of the power source apparatus used in a power storage application.

### DETAILED DESCRIPTION OF THE EMBODIMENTS

The following describes embodiments of the present invention based on the figures. However, the following embodiments are merely specific examples of a power source apparatus representative of the technology associated with the present invention, and the power source apparatus of the present invention is not limited to the embodiments described below. Further, components cited in the claims are in no way limited to the components indicated in the embodiments.

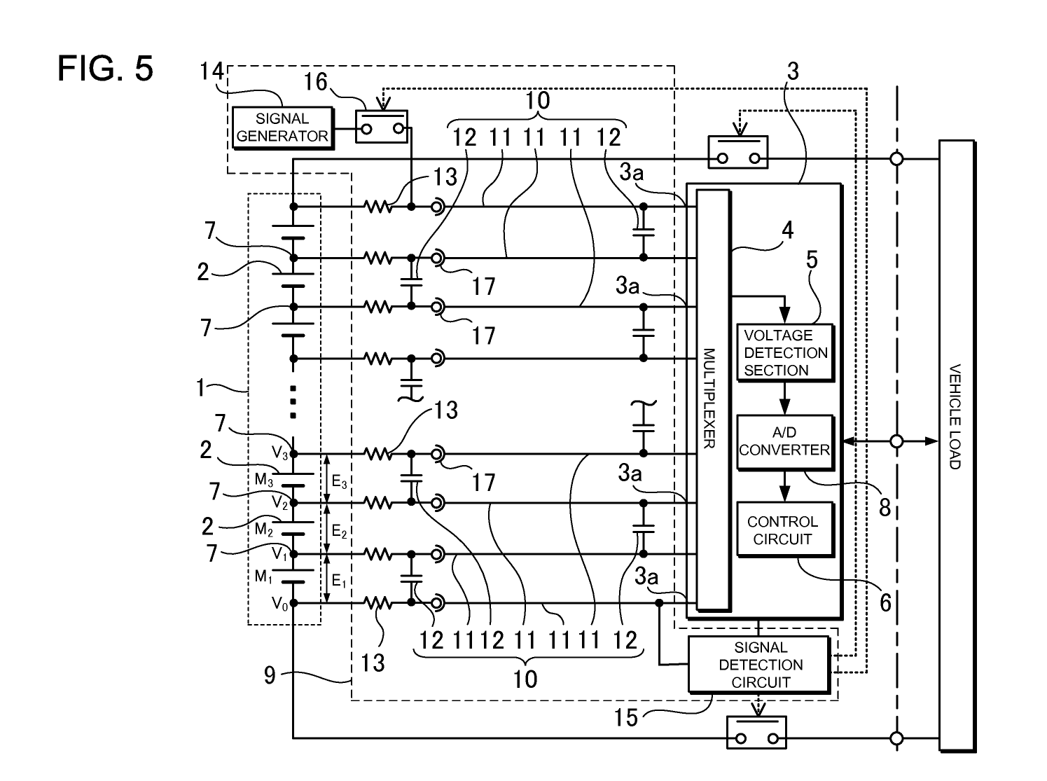

The power source apparatus shown in FIG. 5 is provided with a driving battery 1 that has a plurality of battery modules 2 connected in series, a voltage detection circuit 3 connected to the positive and negative electrode terminals of each battery module 2 via voltage detection lines 11 to detect battery module 2 voltages, and circuitry 9 to detect malfunction in the voltage detection lines 11 that connect each battery module 2 with the voltage detection circuit 3. For example, this power source apparatus can be installed on-board an electric-powered vehicle such as a hybrid vehicle or electric vehicle to deliver power to the motor that drives the vehicle.

A power source apparatus installed on-board a vehicle detects voltage detection line 11 malfunction during initial processing when the ignition key is switched ON. However, the power source apparatus can also detect voltage detection line malfunction when the vehicle is being driven.

The voltage detection circuit 3 is power source apparatus circuitry that detects the voltage of each battery module 2 to facilitate charging and discharging of the battery modules 2 while preventing over-charging and over-discharging. Accordingly, the power source apparatus detects the voltage at each connecting node 7 where battery module 2 electrode terminals are connected in series. The voltage detection circuit 3 can detect voltages at all the connecting nodes 7 to detect the voltages of all the battery modules 2. However, it is not always necessary to detect the voltage at each connecting node. A plurality of series-connected battery modules can also be treated as a single unit, and unit connecting node voltages can be detected to determine the voltage of each unit, which is a plurality of battery modules. For example, in a driving battery with 50 battery modules connected in series, it is desirable to individually detect the voltages of all 50 battery modules with the voltage detection circuit. Or, treating each pair of two battery modules as a single unit, the voltage of each pair of battery modules can be detected as the unit voltage, and 25 unit voltages can be detected.

Detected battery module 2 voltages are used to determine remaining capacity of the battery modules or are used to correct the remaining capacity computed by integrating charging and discharging current. Or, the battery module 2 voltages are used to detect complete discharge when remaining capacity becomes zero and cut-off discharge current in an over-discharging condition, or to detect full-charge and cut-off charging current in an over-charging condition.

The many battery modules 2 connected in series in a driving battery 1 are each charged and discharged by the same current. Accordingly, the charge capacity and the discharge capacity of each battery module 2 should be equivalent. However, electrical characteristics of all the battery modules 2 do not necessarily vary together in an equivalent manner. In particular, when the number of charge-discharge cycles becomes high, the degree of degradation becomes different for each battery module 2 and the capacity attained at full-charge becomes different for each battery module 2. Under these conditions, a battery module 2 with reduced full-charge capacity becomes more easily over-charged or over-discharged. Since battery module 2 electrical characteristics degrade markedly with over-charging or over-discharging, a battery module 2 with reduced full-charge capacity will degrade significantly and abruptly if over-charged or over-discharged. Consequently, while the driving battery 1 has many battery modules 2 connected in series, it is important to prevent over-charging and over-discharging for each battery module 2. Specifically, it is important to charge and discharge battery modules 2 while protecting each battery module 2, and the voltage detection circuit 3 detects battery module 2 voltages for this purpose.

Each battery module 2 has one or a plurality of rechargeable batteries connected in series, parallel, or a combination of series and parallel. The number of series-connected rechargeable batteries in a battery module 2 differs depending on the type of rechargeable battery. For example, a battery module employing lithium ion batteries can be a single rechargeable battery, while a battery module employing nickel-hydride batteries can have four to six rechargeable batteries connected in series. For battery modules made up of one lithium ion battery, 20 battery modules connected in series can produce an output voltage of approximately 74V. For battery modules with five nickel-hydride battery cells connected in series, 50 battery modules connected in series connect a total of 250 battery cells in series to produce an output voltage of approximately 300V.

The voltage detection circuit 3 switches battery module 2 connecting nodes 7 with a multiplexer 4 to sequentially detect the voltage at each connecting node 7. Each connecting node 7 voltage is detected and the voltage of each battery module 2 is computed from the voltage difference between adjacent connecting nodes 7. Each connecting node 7 is connected to the input-side of the voltage detection circuit 3 via a voltage detection line 11. Each voltage detection line 11 is lead-wires and connectors 17 that connect to a driving battery 1 connecting node 7 at one end and to a voltage detection circuit 3 input terminal 3a at the other end.

The voltage of a battery module 2 is detected as the voltage difference between the connecting nodes 7 at the two ends (electrode terminals) of the battery module 2. For example, in FIG. 5, the voltage E2 of battery module M2 is detected from V2-V1, and the voltage E3 of battery module M3 is detected from V3-V2.

The voltage detection circuit 3 in the figure has a voltage detection section 5 connected to the output-side of the multiplexer 4, and an analog-to-digital (ND) converter 8 connected to the output-side of the voltage detection section 5. In this voltage detection circuit 3, the multiplexer 4 is switched sequentially to detect the voltage at each connecting node 7 with the voltage detection section 5, voltage detection section 5 analog output is converted to digital by the ND converter 8, and the digital signals are input to a control circuit 6. The control circuit 6 performs computations with the input digital signals to determine each battery module 2 voltage.

Circuitry 9 to detect voltage detection line 11 malfunction is provided with bypass-capacitors 12 that connect all the voltage detection lines 11 in series and form a series-connected line 10, resistive elements 13 connected between bypass-capacitors 12 at the battery module 2 ends of the voltage detection lines 11 and the battery module 2 electrode terminals, a signal generator 14 connected at one end of the series-connected line 10 that outputs AC or pulse detection signals, and a signal detection circuit 15 connected at the other end of the series-connected line 10 to detect the detection signals issued by the signal generator 14.

The bypass-capacitors 12 are connected at both ends of the voltage detection lines 11, and connect adjacent voltage detection lines 11 in series to form a series-connected line 10 that enables AC transmission. The bypass-capacitors 12 pass AC but do not pass direct current (DC). Accordingly, by connecting the ends of adjacent voltage detection lines 11 via bypass-capacitors 12, the voltage detection lines 11 are connected in series with respect to AC transmission. Bypass-capacitors are alternately connected to opposite ends of adjacent voltage detection lines 11 to connect all the voltage detection lines 11 as a series-connected line 10 with a serpentine structure.

Although the bypass-capacitors 12 connect adjacent voltage detection lines 11 in series with respect to AC, they have a given AC impedance. To connect the voltage detection lines 11 in series in a manner that can easily transmit AC signals, low impedance is implemented. Bypass-capacitor 12 impedance is inversely proportional to capacitance and the frequency of the transmitted AC signal. Accordingly, by making the frequency of the transmitted AC high and the capacitance large, low impedance can be implemented to enable low-loss transmission of AC signals through the voltage detection lines 11.

The resistive elements 13 prevent the bypass-capacitor 12 series-connected voltage detection lines 11 from short-circuiting at the battery module end of the lines. If adjacent voltage detection lines 11 are short-circuited at one end, detection signals supplied at one end of the series-connected line 10 will not be properly transmitted to the other end. This is because battery module internal resistance is significantly low, and without resistive elements 13, each battery module 2 will short-circuit one end of the adjacent voltage detection lines 11.

The resistive elements 13 are connected between the battery modules 2 and the bypass-capacitors 12, and prevent bypass-capacitor 12 short-circuits due to the battery modules 2. A resistive element 13 is a resistor, coil, or series-connection of a resistor and coil. A resistor exhibits electrical resistance to both DC and AC, and a coil has impedance that corresponds to electrical resistance with respect to AC. The electrical resistance and impedance of each resistive element 13 is made large to reduce the possibility of adjacent voltage detection line 11 short-circuit due to the battery modules 2. By making the resistance and impedance of the resistive elements 13 large, short-circuits due to the battery modules 2 can be minimized. To realize this, resistor electrical resistance is made large and coil inductance is made large (to increase the impedance). Coil impedance increases proportional to the inductance and to the frequency of the detection signals supplied to the series-connected line 10.

Short-circuit due to the battery modules 2 can be effectively prevented by making the electrical resistance and impedance of the resistive elements 13 large. However, if resistive element 13 electrical resistance is made too large, voltage drop will develop across the resistive element 13 during battery module 2 voltage detection. The electrical resistance of the resistive element 13 is made a (sufficient) value that allows it to be neglected with respect to the input impedance of the voltage detection circuit 3. Or, since the voltage drop across the resistive element 13 is determined by resistive element 13 resistance and voltage detection circuit 3 input impedance, battery module 2 voltage can be detected while correcting for that voltage drop. Considering short-circuit prevention and battery module 2 voltage detection with enhanced accuracy, resistive element 13 resistance is preferably set from 10KΩ to 1 MΩ. However, resistive element resistance is not limited to this range, and resistance can be below this range and still enable detection signal transmission over the series-connected line while preventing short-circuit due to the battery modules. Further, resistive element resistance can be above this range and still allow battery module voltage detection. In a power source apparatus with coils used as the resistive elements, inductance is set for a coil impedance of 10KΩ to 1 MΩ with respect to the detection signals.

Adjacent voltage detection lines 11 have two series-connected resistive elements 13 connected in parallel with a bypass-capacitor 12. Resistive elements 13 are connected to efficiently transmit detection signals through the bypass-capacitors 12 between adjacent voltage detection lines 11. Efficient detection signal transmission through the bypass-capacitors 12 is achieved by making the electrical resistance and impedance of the resistive elements 13 high and making the bypass-capacitor 12 impedance low. This is preferably implemented by making bypass-capacitor 12 impedance with respect to detection signals lower than the resistive element 13 resistance and impedance. However, since detection signals can be transmitted by the bypass-capacitors even when bypass-capacitor impedance is greater than resistive element resistance, it is not always necessary for bypass-capacitor impedance to be set lower than resistive element resistance.

The signal generator 14 supplies an AC or pulse detection signal to one end of the series-connected line 10. In FIG. 5, the signal generator 14 is connected to one end of the series-connected line 10 and a resistive element 13 through a switch 16. When the signal generator 14 is issuing detection signals, the switch 16 is switched ON and the detection signals are supplied to the series-connected line 10. The switch 16 is turned ON during operation to detect voltage detection line 11 malfunction. For example, in the case of a power source apparatus in a vehicle, the switch 16 is turned ON when the ignition switch is switched ON to detect voltage detection line 11 malfunction while the vehicle is still parked.

The signal detection circuit 15 detects detection signals transmitted through the series-connected line 10 for malfunction detection in all the voltage detection lines 11. For normally functioning voltage detection lines 11 with no open-circuits, detection signals supplied to one end of the series-connected line 10 pass through the series-connected voltage detection lines 11 and bypass-capacitors 12 and are transmitted to the other end. Accordingly, under these conditions the signal detection circuit 15 is able to detect detection signals of a given amplitude. However, if any one of the voltage detection lines 11 is open-circuited, detection signal transmission terminates at the open-circuit location and the signal detection circuit 15 becomes unable to detect any detection signal. Consequently, when detection signals are being output from the signal generator 14 at one end of the series-connected line 10, the signal detection circuit 15 can determine voltage detection line 11 open-circuit by detecting the amplitude of the detection signals.

In addition, it is possible for connector 17 contact resistance to cause inaccurate battery module 2 voltage detection without a voltage detection line 11 open-circuit. This condition can be determined from the amplitude of the signals detected by the signal detection circuit 15. This is because high contact resistance causes detection signal transmission decay at that point, and detection signal amplitude decreases compared to signals under normal conditions. Consequently, a power source apparatus that determines voltage detection line 11 malfunction by detecting detection signals with a signal detection circuit 15 can determine connector 17 and other connecting region contact resistance as well as voltage detection line 11 open-circuit. Contact resistance can occur not only at the connectors 17 but also at other lead-wire connecting regions. If contact resistance malfunction occurs in a region of a voltage detection line 11, the electrical resistance of that region becomes high and results in battery module voltage detection error. A power source apparatus that can detect both voltage detection line 11 contact resistance and open-circuit has the characteristic that accurate battery module 2 voltage can be consistently detected.

When a voltage detection line 11 malfunction is detected, the power source apparatus can, for example, perform charging and discharging while limiting driving battery 1 output to drive the vehicle while protecting the battery modules 2. If voltage detection line 11 malfunction is detected in a hybrid vehicle application, the power source apparatus can be controlled to deliver no power to the motor for engine-only operation, or the vehicle can be put in a non-drivable state. In particular, when an open (disconnected) voltage detection line 11 is detected, operation to drive the vehicle with the power source apparatus is terminated. When voltage detection line 11 contact resistance is detected, a mode of operation such as limiting driving battery 1 output can be implemented. Namely, vehicle operation can be changed depending on whether the malfunction is an open-circuit or contact resistance.

(Power Source Apparatus in a Power Storage Application)

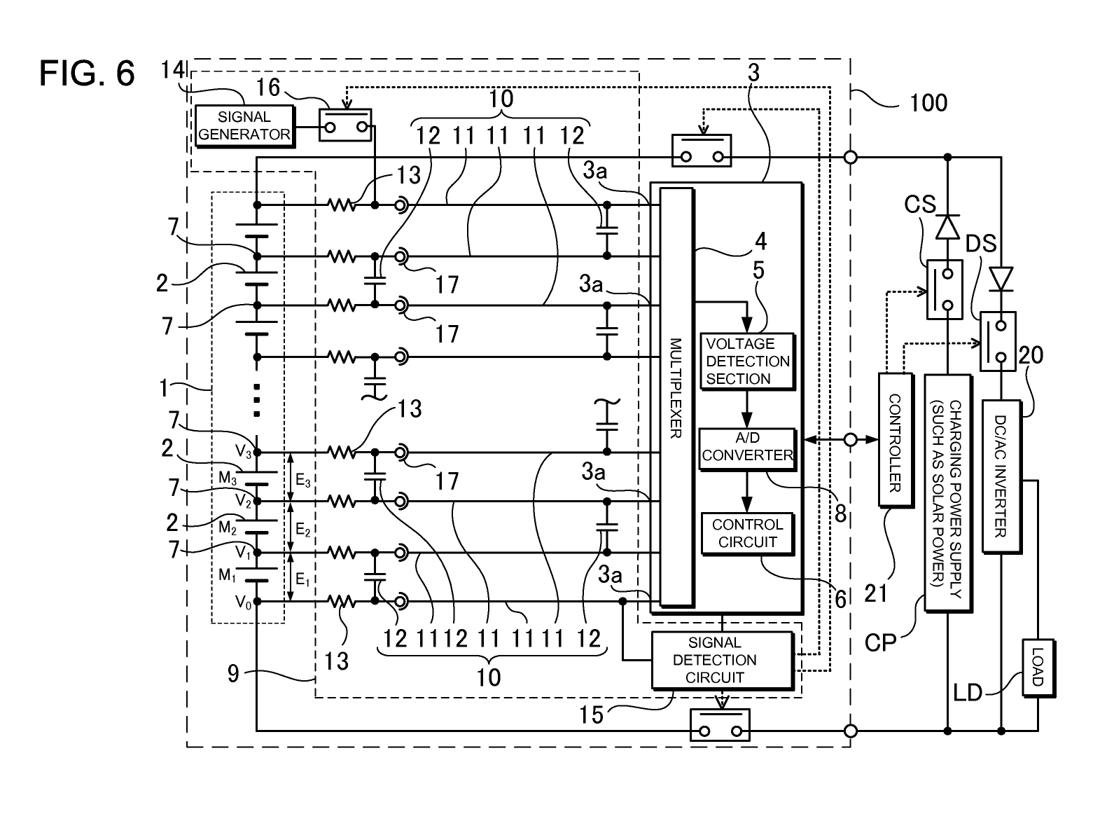

FIG. 6 shows a power source apparatus used as a power storage system. For example, the power source apparatus can be used as a power system in the home or manufacturing facility that is charged by solar power or late-night (reduced-rate) power and discharged as required. It can also be used for applications such as a streetlight power source that is charged during the day by solar power and discharged at night, or as a backup power source to operate traffic signals during power outage. The power source apparatus 100 shown in FIG. 6 has a plurality of battery modules 2 connected in series. The power source apparatus 100 is connected to a charging power supply CP and load LD through a charging switch CS and discharge switch DS respectively. The power source apparatus 100 is charged by the charging power supply CP, and supplies power to the load LD through a DC-to-AC (DC/AC) inverter 20. To accomplish this, the power source apparatus 100 controls the charging switch CS and discharge switch DS via a controller 21 to switch between a charging mode and a discharging mode. The discharge switch DS and the charging switch CS are controlled ON and OFF by the controller 21 based on signals input from the power source apparatus 100. In the charging mode, the controller 21 switches the charging switch CS ON and the discharge switch DS OFF to allow the power source apparatus 100 to be charged from the charging power supply CP. When the power source apparatus 100 is in a charged state with the batteries charged to full-charge or to a battery capacity at or above a given capacity, the controller 21 can switch the discharge switch DS ON to supply power to the load LD depending on demand from the load LD. At that time, the charging switch CS is controlled ON or OFF. The charging switch CS and the discharge switch DS are both controlled ON to supply power to the load LD while charging the power source apparatus 100.

The load LD, which is driven by the power source apparatus 100, is connected to the power source apparatus 100 through the discharge switch DS. In the discharging mode, the controller 21 switches the discharge switch DS ON to connect and drive the load LD with power from the power source apparatus 100. A switching device such as a field effect transistor (FET) can be used as the discharge switch DS, which is controlled ON and OFF by the controller 21. In addition, the power source apparatus 100 is provided with a communication interface (not illustrated) to communicate with externally connected equipment. The communication interface conforms with known protocols such as universal asynchronous receiver transmitter (UART) and recommended standard-232 (RS-232C) protocols to connect the power source apparatus 100 to the load and charging power supply.

1-8. (canceled)

9. A power source apparatus comprising:
a plurality of battery modules connected in series, and
a voltage detection circuit connected to the positive and negative electrode terminals of each battery module via voltage detection lines to detect the voltage of each battery module,
wherein bypass-capacitors are connected at both ends of each voltage detection line to connect all adjacent voltage detection lines in series and form a series-connected line,
a resistive element is connected between the bypass-capacitor at the battery module end of each voltage detection line and the battery module electrode terminal to connect one end of each voltage detection line to a battery module electrode terminal through a resistive element,
a signal generator that outputs AC or pulse detection signals is connected to one end of the series-connected line, which is connected in series via the bypass-capacitors,
the other end of the series-connected line is provided with a signal detection circuit to detect the detection signals output from the signal generator, and
detection signals output from the signal generator are detected by the signal detection circuit to detect failure in the series-connected voltage detection lines.

10. The power source apparatus as cited in claim 9, wherein each resistive element is a resistor or an inductor.

11. The power source apparatus as cited in claim 9, wherein the signal generator is an oscillator that outputs AC with a frequency of 100 KHz to 100 MHz.

12. The power source apparatus as cited in claim 9, wherein the signal generator outputs detection signals to the series-connected line during periods when the voltage detection circuit is not detecting battery module voltages.

13. The power source apparatus as cited in claim 9, wherein bypass-capacitor impedance with respect to detection signals issued by the signal generator is lower than the electrical resistance of the resistive element.

14. A power source apparatus as cited in claim 9 that supplies power to a motor to drive a vehicle.

15. A power source apparatus as cited in claim 9 that is an automotive power source apparatus.

16. A power source apparatus as cited in claim 9 that is used for power storage.
